(19) United States
(12) Patent Application Publication
(10) Pub. No.: US 2020/0025128 A1
(43) Pub. Date: Jan. 23, 2020

(54) AIRCRAFT JET ENGINE COMPRISING MEANS FOR VARYING ITS OUTPUT SURFACE AREA

(71) Applicant: Airbus Operations SAS, Toulouse (FR)

(72) Inventors: Antoine COUSIN, L'UNION (FR); Laurent CALIMAN, TOULOUSE (FR); Jérôme GAILLARDO, CUGNAUX (FR)

(21) Appl. No.: 16/203,829

(22) Filed: Nov. 29, 2018

(30) Foreign Application Priority Data
Dec. 14, 2017 (FR) 1762174

(51) Int. Cl. F02K 1/00; B64C 7/02; B64D 27/18; B64D 29/06; F02K 1/40; F02K 1/80

(52) U.S. Cl. CPC F02K 1/002; B64C 7/02; F02K 1/805; B64D 29/06; F02K 1/40; B64D 27/18

(57) ABSTRACT

A dual flow jet engine comprising a core, a surrounding nacelle, delimiting, with the core, a secondary jet, and having a structure and an outer skin fixed to the structure. The nacelle comprises an annular structure through which windows delimited by the annular structure are produced between the secondary jet and the outside. Each window has a regulation system comprising at least one shutter having an outer face, a leading and a trailing edge. Each shutter is mounted articulated at the nacelle structure window at its leading edge and is mobile between a closed position wherein the trailing edge is close to the outer skin and so the shutter closes the window and an open position where the shutter trailing edge moves outwards away from the outer skin to free the window, and for each shutter, a maneuvering system to displace the shutter between the open and closed positions.

### CROSS-REFERENCES TO RELATED APPLICATIONS

This application claims the benefit of the French patent application No. 1762174 filed on Dec. 14, 2017, the entire disclosures of which are incorporated herein by way of reference.

### BACKGROUND OF THE INVENTION

The present invention relates to an aircraft jet engine comprising means that make it possible to vary its output surface area, and an aircraft comprising at least one such jet engine.

An aircraft conventionally comprises a dual flow jet engine comprising a core comprising compression, combustion and expansion stages, a nacelle arranged around the core and which delimits, with the core, a secondary jet and a fan mounted upstream of the core and of the secondary jet.

When the aircraft is moving forward and the fan is rotating, an air stream passes through the jet engine from upstream to downstream, passing in succession through the fan and the secondary jet.

To perform certain maneuvers, in particular the slowing of the aircraft on the tarmac, the nacelle includes thrust-reversing doors which open inwards across the secondary jet to deflect the air stream from the secondary jet to the outside.

Other than the thrust-reversing doors, such a jet engine does not include any means that make it possible to regulate the air stream at the output of the secondary jet. Thus, if, during a maneuver of the aircraft, it is necessary to evacuate more air from the secondary jet without the thrust-reversing doors being open, there is no technical solution.

### SUMMARY OF THE INVENTION

One object of the present invention is to propose an aircraft dual flow jet engine comprising means that make it possible to vary its output surface area, these means being distinct from the thrust-reversing doors.

To this end, a dual flow jet engine is proposed comprising:

a core,

a nacelle which is arranged around the core, which delimits, with the core, a secondary jet, and which has a structure and an outer skin fixed to the structure, in which the nacelle takes the form of an annular structure through which windows delimited by the annular structure are produced between the secondary jet and the outside, and

a regulating system comprising, for each window:

at least one shutter having an outer face, a leading edge oriented towards the front of the jet engine and a trailing edge oriented towards the rear of the jet engine, in which each shutter is mounted articulated at the window on the structure of the nacelle at its leading edge and is mobile between a closed position in which the trailing edge is close to the outer skin so that the outer face of the shutter is flush with the outer skin and so that the shutter closes the window, and an open position in which the trailing edge of the shutter moves away from the outer skin outwards so as to free the window, and

for each shutter, a maneuvering system intended to displace the shutter from the open position to the closed position and vice versa.

Thus, based on the position of the shutter, the output surface area of the jet engine at its ejection nozzle is modified and it is possible to regulate the output surface area of the secondary jet independently of any other system of the jet engine.

Advantageously, the nacelle comprises thrust-reversing doors and each shutter is arranged downstream of the thrust-reversing doors.

Advantageously, the nacelle comprises an ejection nozzle and each shutter is arranged upstream of the ejection nozzle.

Advantageously, the structure comprises a beam arranged upstream of the leading edge of the shutter, and the maneuvering system comprises at least one jack, in which the or each cylinder of the jack is mounted articulated on the beam and in which the stem of the jack is mounted articulated at the leading edge of the shutter.

Advantageously, the dual flow jet engine comprises, along lateral edges of the shutter, an outer seal and an inner seal, in which the outer seal ensures the seal-tightness between the outside of the nacelle and a space between the fixed part of the nacelle and the shutter, and in which the inner seal ensures the seal-tightness between the secondary jet and the space between the fixed part of the nacelle and the shutter.

Advantageously, the dual flow jet engine comprises, along the leading edge of the shutter, an outer seal and an inner seal, in which the outer seal ensures the seal-tightness between the outside of the nacelle and a space between the fixed part of the nacelle and the shutter, and in which the inner seal ensures the seal-tightness between the secondary jet and the space between the fixed part of the nacelle and the shutter.

The invention also proposes an aircraft comprising at least one dual flow jet engine according to one of the preceding variants.

### BRIEF DESCRIPTION OF THE DRAWINGS

The features of the invention mentioned above, and others, will become more clearly apparent on reading the following description of an exemplary embodiment, the description being given in relation to the attached drawings, in which:

FIG. 1 shows a side view of an aircraft according to the invention,

FIG. 2 shows a side and cross-sectional view of a dual flow jet engine according to the invention,

FIG. 3 shows a side and cross-sectional view of a regulation system in closed position,

FIG. 4 shows a view equivalent to that of FIG. 3 for an open position of the regulation system,

FIG. 5 shows a perspective view of an example of a regulation system maneuvering system,

FIG. 6 shows a cross-sectional view along the line VI-VI of FIG. 5, and

FIG. 7 shows an enlargement of the zone VII of FIG. 3.

### DETAILED DESCRIPTION OF THE PREFERRED EMBODIMENTS

In the following description, the terms relating to a position are taken with reference to the normal direction of advance of an aircraft.

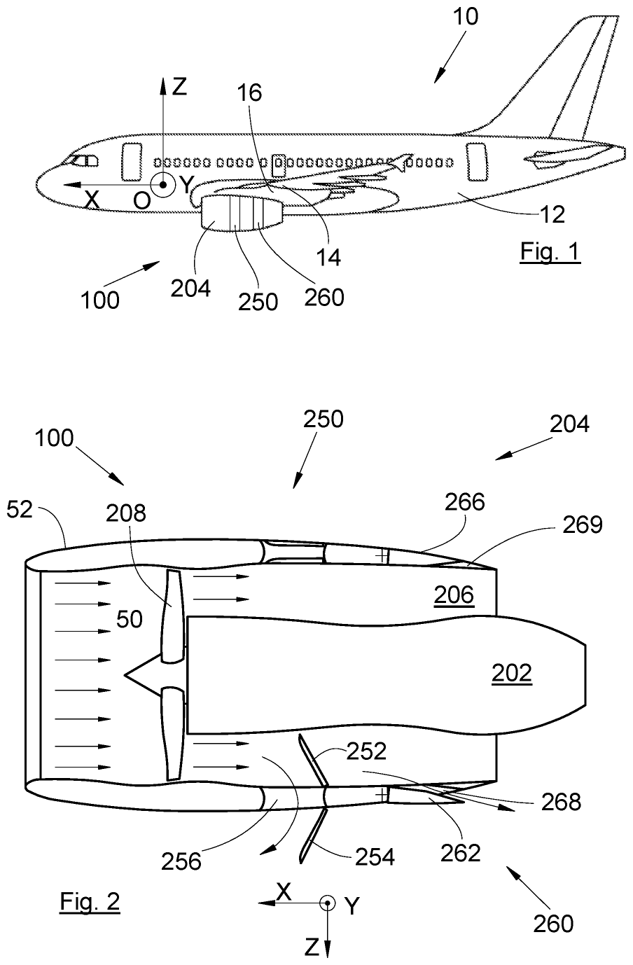

FIG. 1 shows an aircraft 10 which comprises a fuselage 12 on either side of which is fixed a wing 14. Under the wing 14, the aircraft 10 comprises a pylon 16 which supports a dual flow jet engine 100.

In the following description, and by convention, X denotes the longitudinal axis of the aircraft 10, or roll axis, oriented positively in the direction of advance of the aircraft 10, Y denotes the transverse axis or pitch axis of the aircraft which is horizontal when the aircraft is on the ground, and Z denotes the vertical axis or vertical height or yaw axis when the aircraft is on the ground, these three directions X, Y and Z being mutually orthogonal.

FIG. 2 shows the dual flow jet engine 100 which comprises a core 202 comprising compression, combustion and expansion stages, a nacelle 204 arranged around the core 202 and which delimits, with the core 202, a secondary jet 206, and a fan 208 mounted inside the nacelle 204 upstream of the core 202 and of the secondary jet 206.

The nacelle 204 has an outer skin 52 which produces an aerodynamic outer surface along which the air flows.

When the aircraft 10 is advancing and the fan 208 is rotating, an air stream 50 passes through the jet engine 100 from upstream to downstream, passing in succession through the fan 208 and the secondary jet 206.

The nacelle 204 comprises a thrust-reversing system 250 which, in the embodiment of the invention presented in FIG. 2, comprises inner thrust-reversing doors 252 and outer thrust-reversing doors 254. The thrust-reversing doors 252 and 254 are seen in closed position in the top part of FIG. 2 and in open position in the bottom part of FIG. 2.

The thrust-reversing doors 252 and 254 are conventional devices which are mounted to be mobile on the structure of the nacelle 204 and which make it possible, when they are in open position, to free a passage 256 through the nacelle 204 between the secondary jet 206 and the outside of the nacelle 204 in order to evacuate the air from the secondary jet 206 to the outside. The inner thrust-reversing doors 252 open inwards and are oriented towards the core 202, and the outer thrust-reversing doors 254 open outwards.

In another embodiment, the thrust-reversing system 250 can comprise only the inner thrust-reversing doors 252.

The thrust-reversing doors 252 and 254 are displaced between the open position and the closed position by any suitable driving system known to the person skilled in the art, for example based on a motor, jack, etc.

The nacelle 204 takes the form of an annular structure through which the windows 268 are produced between the secondary jet 206 and the outside, that is to say, that each window 268 is delimited on its four edges by the annular structure. In particular, the rear edge of each window is upstream of the ejection nozzle 269 of the nacelle 204 relative to the direction of flow of the air in the nacelle 204. The annular structure makes it possible to ensure the stiffness of the nacelle 204, in particular at its trailing edge, and therefore the control of the output section even when the shutters 262 described below are closed but also, and above all, open by limiting the deformations of the nacelle 204.

The nacelle 204 also comprises a regulation system 260 (of VAN, for variable area nozzle, type) which comprises shutters 262, the number of which depends on the dimensions of the shutters 262, on the diameter of the nacelle 204 and on the dimensions of the windows 268. The rest of the description is described for a single shutter 262, but it applies to each shutter 262. Likewise, one shutter 262 per window 268 is described, but different numbers can be considered depending on the dimensions.

One such regulation system 260 makes it possible to regulate the air stream in the secondary jet 206 to ensure a sufficient surge margin for the fan 208.

The shutter 262 has a leading edge oriented towards the front of the jet engine 100 and a trailing edge oriented towards the rear of the jet engine 100.

The shutter 262 is mounted articulated at a window 268 on the structure of the nacelle 204. The shutter 262 is mounted articulated at its leading edge and is mobile between an open position and a closed position and vice versa.

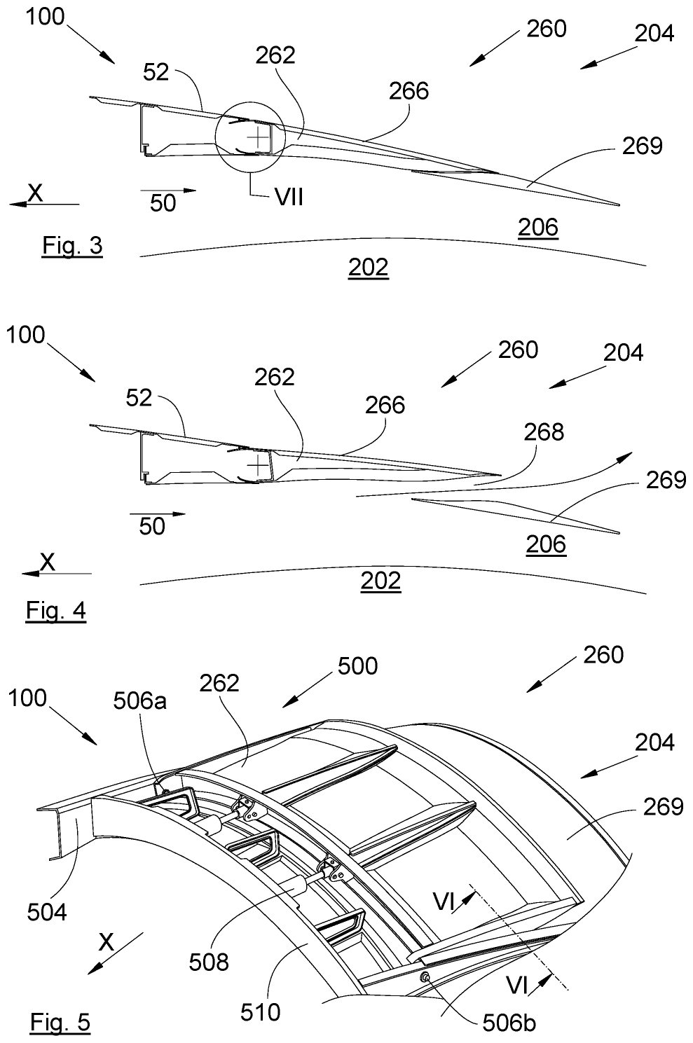

FIG. 3 and the top part of FIG. 2 show the shutter 262 in closed position and FIG. 4 and the bottom part of FIG. 2 show the shutter 262 in open position.

The shutter 262 has an outer face 266 which is oriented towards the outside of the nacelle 204.

In closed position, the shutter 262 is stowed so that its outer face 266 is flush with the outer skin 52 of the nacelle 204 in order to not disrupt the flow of the air around the nacelle 204. In closed position, the trailing edge is close to the outer skin 52 and the shutter 262 closes the window 268.

In open position, the trailing edge of the shutter 262 moves away from the outer skin 52 outwards, so as to free the window 268. Thus, the nacelle 204 is crossed by the window 268 which is blocked by the shutter 262 in closed position and which is open in open position of the shutter 262.

Thus, based on the position of the shutter 262, the output surface area of the nacelle 204 at its ejection nozzle 269 is modified.

Each shutter 262 is arranged upstream of the ejection nozzle 269 of the nacelle 204 relative to the direction of flow of the air in the nacelle 204.

Each shutter 262 is mounted to be rotationally mobile on the structure of the nacelle 204 about an axis of rotation that is overall at right angles to the longitudinal axis X. Each shutter 262 is thus mounted to be mobile relative to a fixed part of the nacelle 204 and is arranged downstream of the fixed part.

Each shutter 262 is arranged downstream of the thrust-reversing doors 252 and 254 relative to the direction of flow of the air in the nacelle 204.

Although in FIG. 2 the thrust-reversing doors 252 and 254 and the shutters 262 are shown open and closed at the same time, the positions of the thrust-reversing doors 252 and 254 and of the shutters 262 are independent. For example, the thrust-reversing doors 252 and 254 can be in closed position while the shutters 262 are in open position and vice versa.

The regulation system 260 also comprises, for each shutter 262, a maneuvering system which is provided to displace the shutter 262 from the open position to the closed position and vice versa.

The maneuvering system can take different forms and comprises, for example, motors, jacks, etc.

FIG. 5 shows a maneuvering system 500 according to a particular embodiment.

The shutter 262 is mounted to be rotationally mobile on the structure 504 of the nacelle 204 via two pivot links 506a-b.

The structure 504 comprises a beam 510 which is arranged upstream of the leading edge of the shutter 262 relative to the direction of flow of the air in the nacelle 204.

The maneuvering system 500 comprises at least one jack 508, here two of them, in which, for the or each jack 508, the cylinder of the jack 508 is mounted articulated on the beam 510 and the stem of the jack 508 is mounted articulated at the leading edge of the shutter 262. The articulations are produced, for example, by gimbal joints so as to absorb the reaction torque of the actuator and/or of the ball joints.

Each jack 508 is controlled by a control unit of the aircraft 10 which commands it to extend or retract the stem as a function of the desired position for the shutter 262.

To limit the aerodynamic disturbances, in particular at the leading edge of the shutter 262, seals are provided between the fixed part of the nacelle 204 and the shutter 262.

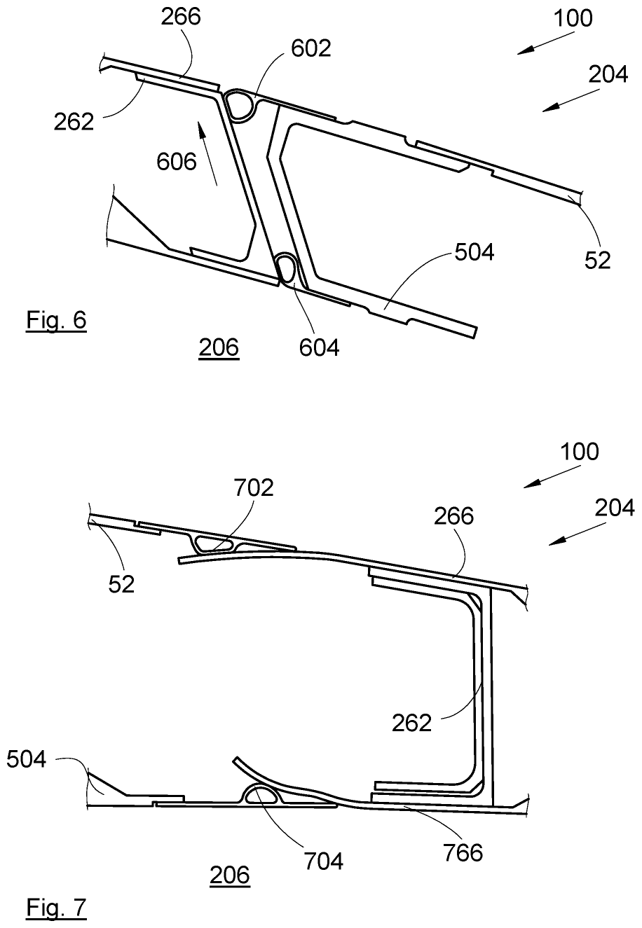

FIG. 6 and FIG. 7 show the placement of a set of seals between the fixed part of the nacelle 204 and the shutter 262.

As FIG. 6 shows, the set of seals comprises, along the lateral edges of the shutter 262, an outer seal 602 and an inner seal 604. The lateral edges of the shutter 262 extend overall from front to rear, that is to say, overall parallel to the longitudinal axis X.

The outer seal 602 ensures the seal-tightness along the lateral edges of the shutter 262 between the outside of the nacelle 204 and the space between the fixed part of the nacelle 204 and the shutter 262. The inner seal 604 ensures the seal-tightness between the inside of the nacelle 204, that is to say the secondary jet 206, and the space between the fixed part of the nacelle 204 and the shutter 262.

The outer seal 602 and the inner seal 604 thus form a double sealing barrier between the outside of the nacelle 204 and the secondary jet 206, whether the shutter 262 is in closed position or in open position embodied by the arrow 606 showing the direction of opening of the shutter 262.

The outer seal 602 and the inner seal 604 here each take the form of a hollow roll which is fixed to the fixed part of the nacelle 204 and which bears against a lateral edge of the shutter 262.

As FIG. 7 shows, the set of seals comprises, along the leading edge of the shutter 262, an outer seal 702 and an inner seal 704.

The outer seal 702 ensures the seal-tightness at the leading edge of the shutter 262 between the outside of the nacelle 204 and the space between the fixed part of the nacelle 204 and the shutter 262. The inner seal 704 ensures the seal-tightness at the leading edge of the shutter 262 between the inside of the nacelle 204, that is to say the secondary jet 206, and the space between the fixed part of the nacelle 204 and the shutter 262.

The outer seal 702 and the inner seal 704 here each take the form of a hollow roll which is fixed to the fixed part of the nacelle 204. The outer seal 702 bears against the outer face 266. The inner seal 704 bears against an inner face 766 of the shutter 262 which is oriented towards the interior of the nacelle 204, and more particularly towards the secondary jet 206.

During the displacement of the shutter 262, the outer seal 702 and the inner seal 704 slide over the face 266, 766 against which it bears. The outer seal 702 and the inner seal 704 thus form a double sealing barrier between the outside of the nacelle 204 and the secondary jet 206 at the leading edge of the shutter 262.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A dual flow jet engine comprising:
a core,
a nacelle arranged around the core, which delimits, with the core, a secondary jet, and which has a structure and an outer skin fixed to the structure facing an outside, in which the nacelle forms an annular structure through which windows, delimited by the annular structure, are produced between the secondary jet and the outside, and
a regulation system comprising, for each window:
at least one shutter having an outer face, a leading edge oriented towards a front of the jet engine and a trailing edge oriented towards a rear of the jet engine, in which each shutter is mounted articulated at the window on the structure of the nacelle at its leading edge and is mobile between a closed position in which the trailing edge is close to the outer skin so that the outer face of the shutter is flush with the outer skin and so that the shutter closes the window, and an open position in which the trailing edge of the shutter moves away from the outer skin outwards, so as to free the window, and
for each shutter, a maneuvering system configured to displace the shutter from the open position to the closed position and vice versa.

2. The dual flow jet engine according to claim 1, wherein the nacelle comprises thrust-reversing doors and in that each shutter is arranged downstream of the thrust-reversing doors.

3. The dual flow jet engine according to claim 1, wherein the nacelle comprises an ejection nozzle and wherein each shutter is arranged upstream of the ejection nozzle.

4. The dual flow jet engine according to claim 1, wherein the structure comprises a beam arranged upstream of the leading edge of the shutter, and wherein the maneuvering system comprises at least one jack, in which, for each at least one jack, a cylinder of the jack is mounted articulated on the beam and a stem of the jack is mounted articulated at the leading edge of the shutter.

5. The dual flow jet engine according to claim 1, further comprising, along lateral edges of the shutter, an outer seal and an inner seal, wherein the outer seal ensures a seal-tightness between the outside of the nacelle and a space between a fixed part of the nacelle and the shutter, and wherein the inner seal ensures a seal-tightness between the secondary jet and the space between the fixed part of the nacelle and the shutter.

6. A dual flow jet engine according to claim 1, further comprising, along the leading edge of the shutter, an outer seal and an inner seal, in which the outer seal ensures a seal-tightness between the outside of the nacelle and a space between a fixed part of the nacelle and the shutter, and wherein the inner seal ensures a seal-tightness between the secondary jet and the space between the fixed part of the nacelle and the shutter.

7. An aircraft comprising at least one dual flow jet engine according to claim 1.
